(19) United States
(12) Patent Application Publication
(10) Pub. No.: US 2026/0176842 A1
(43) Pub. Date: Jun. 25, 2026

(54) WORK MACHINE

(71) Applicant: SUMITOMO CONSTRUCTION MACHINERY CO., LTD., Tokyo (JP)

(72) Inventors: Kai IKUTA, Chiba (JP); Nobutada SAKATA, Chiba (JP)

(21) Appl. No.: 19/425,279

(22) Filed: Dec. 18, 2025

(30) Foreign Application Priority Data
Dec. 23, 2024 (JP) 2024-226723

(51) Int. Cl. E02F 9/22; F15B 13/04; F15B 15/18

(52) U.S. Cl. CPC E02F 9/2203; E02F 9/2267; E02F 9/2292; F15B 13/0401; F15B 15/18; E02F 9/2285; E02F 9/2296

(57) ABSTRACT

A work machine includes a lower traveling body; an upper swing body configured to be swingably mounted on the lower traveling body; a hydraulic actuator; a hydraulic pump configured to supply hydraulic oil to the hydraulic actuator; a first control valve provided in a first oil passage connecting the hydraulic pump and a hydraulic oil tank; a second control valve provided in a second oil passage connecting the hydraulic pump and the hydraulic actuator; and a third control valve provided between the hydraulic pump and the second control valve in the second oil passage. The third control valve is configured to shut off the second oil passage when a load on a drive source is intentionally increased.

### CROSS-REFERENCE TO RELATED APPLICATIONS

This application is based on and claims priority to Japanese Patent Application No. 2024-226723, filed on December 23, 2024, the entire contents of which are incorporated herein by reference.

### BACKGROUND

### Technical Field

The present disclosure relates to a work machine.

### Description of Related Art

A work machine (a hydraulic excavator) including a hydraulic pump driven by a drive source (an engine) is known. The hydraulic excavator is configured to intentionally increase the load on the engine in order to perform a specific process. The specific process is, for example, a process of increasing the temperature of exhaust gas in order to burn particulate matter collected in a filter of an exhaust gas purification device by the heat of the exhaust gas. Further, the hydraulic excavator is configured to increase the load on the engine by increasing the discharge pressure of a hydraulic pump when an operation lever is not operated.

### SUMMARY

A work machine according to an embodiment of the present disclosure includes a lower traveling body; an upper swing body configured to be swingably mounted on the lower traveling body; a hydraulic actuator; a hydraulic pump configured to supply hydraulic oil to the hydraulic actuator; a first control valve provided in a first oil passage connecting the hydraulic pump and a hydraulic oil tank; a second control valve provided in a second oil passage connecting the hydraulic pump and the hydraulic actuator; and a third control valve provided between the hydraulic pump and the second control valve in the second oil passage. The third control valve is configured to shut off the second oil passage when a load on a drive source is intentionally increased.

### BRIEF DESCRIPTION OF THE DRAWINGS

FIG. 1 is a side view of a work machine according to an embodiment of the present disclosure;

FIG. 2 is a schematic diagram illustrating an example configuration of a hydraulic drive system installed in the work machine of FIG. 1;

FIG. 3 is a flowchart illustrating an example of the flow of a forced high-load process;

FIG. 4 is a diagram illustrating an example state of the hydraulic drive system illustrated in FIG. 2;

FIG. 5 is a diagram illustrating another example state of the hydraulic drive system illustrated in FIG. 2;

FIG. 6 is a diagram illustrating yet another example state of the hydraulic drive system illustrated in FIG. 2;

FIG. 7 is a diagram illustrating yet another example state of the hydraulic drive system illustrated in FIG. 2; and

FIG. 8 is a schematic diagram illustrating an example configuration of another hydraulic drive system installed in the work machine of FIG. 1.

### DETAILED DESCRIPTION

The hydraulic excavator in the related art is configured to increase the discharge pressure of the hydraulic pump by causing a control valve (control valve for controlling the supply and discharge of hydraulic oil into and from the hydraulic cylinder) provided in an oil passage connecting a hydraulic cylinder and the hydraulic pump to shut off the flow of hydraulic oil in the oil passage. Therefore, in the hydraulic excavator described above, there is a possibility that the pressure of the hydraulic oil on the upstream side of the control valve unavoidably increases and becomes higher than the pressure of the hydraulic oil on the downstream side of the control valve over a period of time during which a process for intentionally increasing the load on the engine is performed, and as a result, leakage of the hydraulic oil from the upstream side to the downstream side of the control valve cannot be suppressed.

In view of the above, it is desirable to provide a work machine that can intentionally increase the load on a drive source while suppressing an increase in a pressure difference across a control valve, which is a difference between the pressure of hydraulic oil on the upstream side of the control valve and the pressure of hydraulic oil on the downstream side of the control valve when the pressure of the hydraulic oil on the upstream side is larger than the pressure of the hydraulic oil on the downstream side.

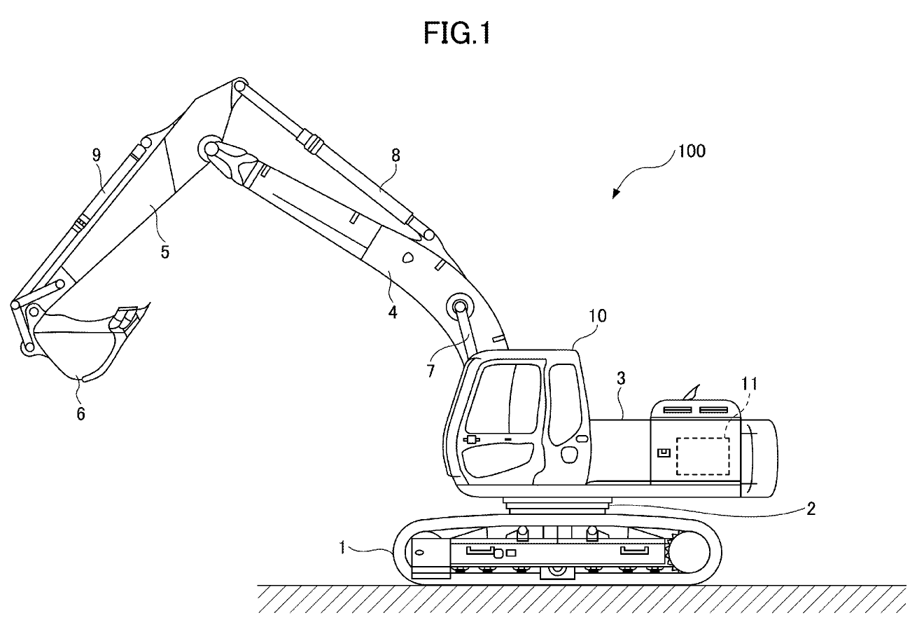

First, a work machine 100 according to an embodiment of the present disclosure will be described with reference to FIG. 1. FIG. 1 is a side view of the work machine 100. The work machine 100 illustrated in FIG. 1 is an excavator (a shovel), and includes a lower traveling body 1, a swing mechanism 2, and an upper swing body 3. The upper swing body 3 is swingably mounted on the lower traveling body 1 via the swing mechanism 2. A boom 4 serving as a working member is attached to the upper swing body 3. An arm 5 serving as a working member is attached to the tip of the boom 4, and a bucket 6 serving as a working member and an end attachment is attached to the tip of the arm 5. The boom 4, the arm 5, and the bucket 6 constitute an excavation attachment, which is an example of an attachment. The boom 4 is driven by a boom cylinder 7, the arm 5 is driven by an arm cylinder 8, and the bucket 6 is driven by a bucket cylinder 9. The upper swing body 3 is provided with a cabin 10 and a drive source 11. The work machine 100 may be any other work machine including hydraulic actuators that can intentionally increase the load on the drive source 11, such as a wheel loader, a crane, an asphalt finisher, or a forklift.

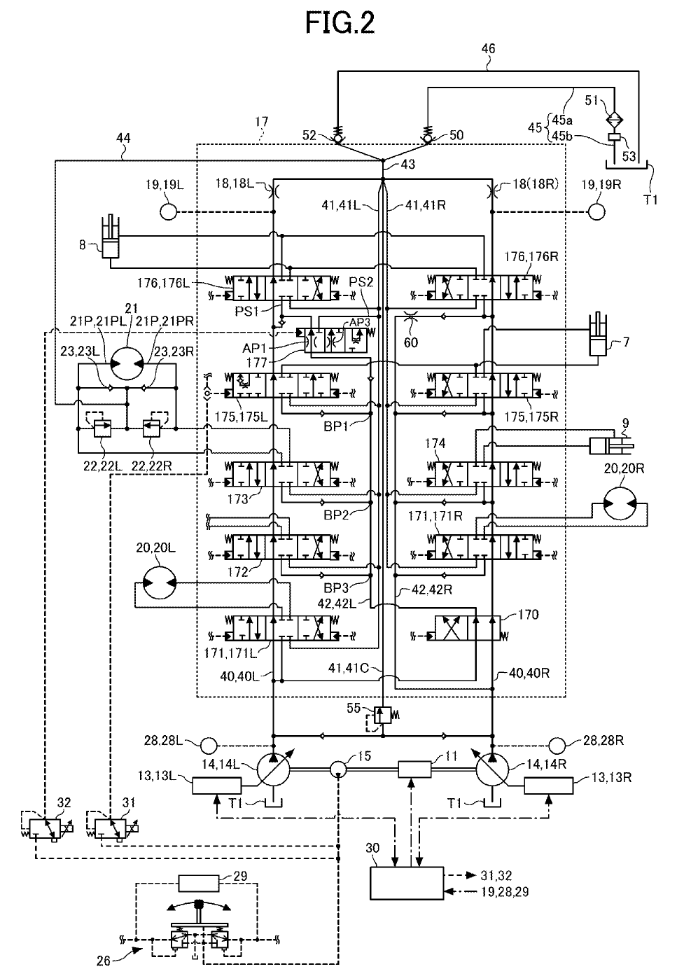

FIG. 2 is a diagram illustrating an example configuration of a hydraulic drive system installed in the work machine 100 of FIG. 1. In FIG. 2, a mechanical power transmission system is indicated by a double line, a hydraulic oil line is indicated by a solid line, a pilot line is indicated by a dashed line, and an electric control line is indicated by a dash-dot line.

The hydraulic drive system of the work machine 100 mainly includes the drive source 11, a pump regulator 13, a main pump 14, a pilot pump 15, an operation device 26, a discharge pressure sensor 28, an operation sensor 29, a controller 30, and the like.

The drive source 11 is a drive source of the work machine 100. The drive source 11 may be an electric motor driven by an external power source, a battery, a fuel cell, or the like, an internal combustion engine driven by gasoline, diesel fuel, hydrogen, biofuel, or the like, or a hybrid drive source combining an internal combustion engine and an electric motor. In the illustrated example, the drive source 11 is a diesel engine that operates to maintain a predetermined rotational speed. An output shaft of the drive source 11 is coupled to an input shaft of the main pump 14 and an input shaft of the pilot pump 15.

The load on the drive source 11 is intentionally increased when regeneration control of an exhaust gas aftertreatment device such as a diesel particulate filter (DPF), thawing and warming control of urea water, freezing prevention control of a blow-by gas pipe, air conditioner control (heating control), or warm-up control of a hydraulic drive system is performed. This is because the above-described various processes are performed by utilizing thermal energy generated by increasing the load on the drive source 11. Further, it is desirable to intentionally increase the load on the drive source 11 without operating a hydraulic actuator installed in the work machine 100. Therefore, in the illustrated example, the work machine 100 increases the load on the drive source 11 by shutting off an oil passage through which hydraulic oil discharged by the main pump 14 flows so as to increase the discharge pressure of the main pump 14 and increase the hydraulic load (pump torque) without operating the attachment.

The main pump 14 is an example of a hydraulic pump, and is configured to supply hydraulic oil to a control valve unit 17. In the illustrated example, the main pump 14 is a swash plate variable displacement hydraulic pump, and includes a left main pump 14L and a right main pump 14R.

The pump regulator 13 is configured to control the discharge amount of the main pump 14. In the illustrated example, the pump regulator 13 controls the discharge amount of the main pump 14 by adjusting the swash plate tilt angle of the main pump 14 in response to a command from the controller 30. The pump regulator 13 may output information relating to the swash plate tilt angle to the controller 30. Specifically, the pump regulator 13 includes a left pump regulator 13L configured to control the discharge amount of the left main pump 14L, and a right pump regulator 13R configured to control the discharge amount of the right main pump 14R.

The pilot pump 15 is configured to supply hydraulic oil to various hydraulic devices including the operation device 26. In the illustrated example, the pilot pump 15 is a fixed displacement hydraulic pump. However, the pilot pump 15 may be omitted. In such a case, the function of the pilot pump 15 may be implemented by the main pump 14. That is, in addition to the function for supplying hydraulic oil to the control valve unit 17, the main pump 14 may have a function for supplying hydraulic oil to the operation device 26 and the like after the pressure of the hydraulic oil is reduced by a throttle or the like.

The control valve unit 17 accommodates a plurality of control valves such that the control valves are operable. In the illustrated example, the control valve unit 17 includes a plurality of control valves 170 to 177 configured to control the flow of hydraulic oil discharged by the main pump 14. The control valve unit 17 is configured to selectively supply the hydraulic oil discharged by the main pump 14 to one or more hydraulic actuators through the control valves 170 to 177. The plurality of control valves 170 to 177 control the flow rate of the hydraulic oil flowing from the main pump 14 to the hydraulic actuators and the flow rate of the hydraulic oil flowing from the hydraulic actuators to a hydraulic oil tank T1.

The hydraulic actuators may be hydraulic cylinders or hydraulic motors. The hydraulic cylinders may be single-rod hydraulic cylinders or double-rod hydraulic cylinders. In the illustrated example, the hydraulic actuators include the boom cylinder 7, the arm cylinder 8, the bucket cylinder 9, a travel hydraulic motor 20, and a swing hydraulic motor 21. The travel hydraulic motor 20 includes a left travel hydraulic motor 20L and a right travel hydraulic motor 20R.

The swing hydraulic motor 21 is a hydraulic motor that swings the upper swing body 3. An oil passage 21P connected to a port of the swing hydraulic motor 21 is connected to an oil passage 44 via a relief valve 22 and a check valve 23. Specifically, the oil passage 21P includes a left oil passage 21PL and a right oil passage 21PR. The relief valve 22 includes a left relief valve 22L and a right relief valve 22R. The check valve 23 includes a left check valve 23L and a right check valve 23R.

The left relief valve 22L opens to discharge hydraulic oil in the left oil passage 21PL to the oil passage 44 when the pressure of hydraulic oil in the left oil passage 21PL reaches a predetermined relief pressure. Further, the right relief valve 22R opens to discharge hydraulic oil in the right oil passage 21PR to the oil passage 44 when the pressure of hydraulic oil in the right oil passage 21PR reaches a predetermined relief pressure.

The left check valve 23L opens to supply hydraulic oil from the oil passage 44 to the left oil passage 21PL when the pressure of hydraulic oil in the left oil passage 21PL becomes lower than the pressure of hydraulic oil in the oil passage 44. The right check valve 23R opens to supply hydraulic oil from the oil passage 44 to the right oil passage 21PR when the pressure of hydraulic oil in the right oil passage 21PR becomes lower than the pressure of hydraulic oil in the oil passage 44. This configuration enables the check valve 23 to supply hydraulic oil to the intake side port at the time of braking the swing hydraulic motor 21.

The operation device 26 is a device used by an operator to operate the hydraulic actuators. In the illustrated example, the operation device 26 is a hydraulic type, and supplies hydraulic oil discharged by the pilot pump 15 to a pilot port of a control valve corresponding to each hydraulic actuator via a pilot line. A pilot pressure, which is the pressure of hydraulic oil supplied to each pilot port, is a pressure commensurate with the direction of operation and the amount of operation of an operation lever or an operation pedal of the operation device 26 corresponding to each hydraulic actuator. The operation device 26 may be an electric type.

Specifically, the operation device 26 includes a left operation lever, a right operation lever, a left travel operation lever, a right travel lever, a left travel operation pedal, and a right travel operation pedal. The left operation lever functions as an arm operation lever and a swing operation lever. The right operation lever functions as a boom operation lever and a bucket operation lever. In the following, at least one of the left operation lever or the right operation lever may be referred to as an “attachment operation device”, and at least one of the left travel lever, the right travel lever, the left travel pedal, or the right travel pedal may be referred to as a “travel operation device”.

The discharge pressure sensor 28 is configured to detect the discharge pressure of the main pump 14 and output a detected value to the controller 30. In the illustrated example, the discharge pressure sensor 28 includes a left discharge pressure sensor 28L that detects the discharge pressure of the left main pump 14L, and a right discharge pressure sensor 28R that detects the discharge pressure of the right main pump 14R.

The operation sensor 29 is a device for detecting the details of the operator’s operation using the operation device 26. Examples of operation details include the direction of operation and the amount of operation (the angle of operation). In the illustrated example, the operation sensor 29 is a pressure sensor that detects the direction of operation and the amount of operation of a lever or a pedal of the operation device 26 corresponding to each hydraulic actuator in the form of pressure, and outputs a detected value to the controller 30. However, the operation details of the operation device 26 may be detected by using the output of a device other than a pressure sensor, such as an operating angle sensor, an acceleration sensor, an angular velocity sensor, a resolver, a voltmeter, or an ammeter.

The controller 30 is an example of processing circuitry, and functions as a control device for controlling the work machine 100. In the illustrated example, the controller 30 is configured with a computer including a CPU, a volatile storage, and a nonvolatile storage.

An electromagnetic valve 31 is provided in an oil passage that connects the pilot pump 15 to a left pilot port of a control valve 175L in the control valve unit 17, and is configured to change the flow area of the oil passage. In the illustrated example, the electromagnetic valve 31 is an electromagnetic proportional control valve that operates in response to a control command output from the controller 30. With this configuration, the controller 30 can automatically operate the control valve 175L regardless of whether a boom lowering operation is performed by the operator. Further, in the illustrated example, the left pilot port of the control valve 175L is configured such that the higher one of a pilot pressure generated by the electromagnetic valve 31 or a pilot pressure generated by the boom operation lever acts on the left pilot port.

An electromagnetic valve 32 is provided in an oil passage that connects the pilot pump 15 to a left pilot port of the control valve 177 in the control valve unit 17, and is configured to change the flow area of the oil passage. In the illustrated example, the electromagnetic valve 32 is an electromagnetic proportional control valve that operates in response to a control command output from the controller 30. With this configuration, the controller 30 can automatically operate the control valve 177.

A center bypass oil passage 40 is a hydraulic oil line passing through the control valves disposed in the control valve unit 17, and includes a left center bypass oil passage 40L and a right center bypass oil passage 40R.

The control valve 170 is a spool valve serving as a straight traveling valve. In the illustrated example, the control valve 170 is configured to switch the flow of hydraulic oil so that the hydraulic oil is supplied from the main pump 14 to the travel hydraulic motor 20 in order to increase the straightness of traveling of the lower traveling body 1. Specifically, the valve position of the control valve 170 is configured to be switched between a first valve position (left valve position) and a second valve position (right valve position) in response to a control command from the controller 30.

More specifically, the control valve 170 is in the first valve position when only the travel operation device is operated or when only the attachment operation device is operated, and is in the second valve position when the travel operation device and the attachment operation device are simultaneously operated.

The first valve position is a valve position in which the left main pump 14L and the left travel hydraulic motor 20L are brought into communication with each other and the right main pump 14R and the right travel hydraulic motor 20R are brought into communication with each other. In this state, the left main pump 14L can supply hydraulic oil to the left travel hydraulic motor 20L, and the right main pump 14R can supply hydraulic oil to the right travel hydraulic motor 20R.

The second valve position is a valve position in which the left main pump 14L is brought into communication with each of the left travel hydraulic motor 20L and the right travel hydraulic motor 20R. In this state, the left main pump 14L can supply hydraulic oil to each of the left travel hydraulic motor 20L and the right travel hydraulic motor 20R.

The control valve 171 is a spool valve that switches the flow of hydraulic oil to supply hydraulic oil discharged by the main pump 14 to the travel hydraulic motor 20 and discharge hydraulic oil discharged by the travel hydraulic motor 20 to the hydraulic oil tank T1. Specifically, the control valve 171 includes a control valve 171L and a control valve 171R. The control valve 171L switches the flow of hydraulic oil to supply hydraulic oil discharged by the left main pump 14L to the left travel hydraulic motor 20L and discharge hydraulic oil discharged by the left travel hydraulic motor 20L to the hydraulic oil tank T1. The control valve 171R switches the flow of hydraulic oil to supply hydraulic oil discharged by the left main pump 14L or the right main pump 14R to the right travel hydraulic motor 20R and discharge hydraulic oil discharged by the right travel hydraulic motor 20R to the hydraulic oil tank T1.

The control valve 172 is a spool valve that switches the flow of hydraulic oil to supply hydraulic oil discharged by the left main pump 14L to an optional hydraulic actuator and discharge hydraulic oil discharged by the optional hydraulic actuator to the hydraulic oil tank T1. The optional hydraulic actuator is, for example, a grapple drive cylinder or a breaker drive cylinder.

The control valve 173 is a spool valve that switches the flow of hydraulic oil to supply hydraulic oil discharged by the left main pump 14L to the swing hydraulic motor 21 and discharge hydraulic oil discharged by the swing hydraulic motor 21 to the hydraulic oil tank T1.

The control valve 174 is a spool valve that switches the flow of hydraulic oil to supply hydraulic oil discharged by the right main pump 14R to the bucket cylinder 9 and discharge hydraulic oil in the bucket cylinder 9 to the hydraulic oil tank T1.

The control valve 175 is a spool valve that switches the flow of hydraulic oil to supply hydraulic oil discharged by the main pump 14 to the boom cylinder 7 and discharge hydraulic oil in the boom cylinder 7 to the hydraulic oil tank T1. Specifically, the control valve 175 includes the control valve 175L and a control valve 175R.

In the illustrated example, the control valve 175L is configured such that the valve position is switched among a first valve position (left valve position), a second valve position (right valve position), and a third valve position (center valve position) in response to a control command from the controller 30. The control valve 175L is in the first valve position when a boom lowering operation is performed, is in the second valve position when a boom raising operation is performed, and is in the third valve position (center valve position), which serves as an initial valve position, when neither a boom raising operation nor a boom lowering operation is performed. Specifically, the control valve 175L is in the first valve position when a boom lowering operation is performed, and can cause hydraulic oil in a bottom-side oil chamber of the boom cylinder 7 to flow into the left center bypass oil passage 40L. Therefore, the control valve 175L can cause hydraulic oil flowing out of the bottom-side oil chamber of the boom cylinder 7 to flow (regenerate) into the arm cylinder 8 when the boom lowering operation is performed. Note that, in the control valve 175L, an oil passage for causing hydraulic oil in the bottom-side oil chamber of the boom cylinder 7 to flow into the left center bypass oil passage 40L may be omitted. A holding valve (not illustrated) for preventing the boom 4 from moving due to its own weight or the like when a boom operation is not performed (a valve for preventing hydraulic oil from flowing out of the boom cylinder 7) is provided between the boom cylinder 7 and the control valve 175. The holding valve does not stop hydraulic oil from flowing into the boom cylinder 7. Further, the control valve 175L is in the second valve position when a boom raising operation is performed, and can cause hydraulic oil discharged by the left main pump 14L to flow into the bottom-side oil chamber of the boom cylinder 7. Similar to the control valve 175L, the control valve 175R can cause hydraulic oil discharged by the right main pump 14R to flow into the bottom-side oil chamber of the boom cylinder 7 when a boom raising operation is performed. Further, the control valve 175R can cause hydraulic oil discharged by the right main pump 14R to flow into a rod-side oil chamber of the boom cylinder 7 when a boom lowering operation is performed.

The control valve 176 is a spool valve that switches the flow of hydraulic oil to supply hydraulic oil discharged by the main pump 14 to the arm cylinder 8 and discharge hydraulic oil in the arm cylinder 8 to the hydraulic oil tank T1. Specifically, the control valve 176 includes a control valve 176L and a control valve 176R.

The control valve 177 is a spool valve that restricts the flow rate of hydraulic oil flowing through a left parallel oil passage 42L, which will be described later, to the control valve 176L, and is also referred to as a “sub-spool valve” or a “cut-off valve”. The “sub-spool valve” is used in contrast to a “main spool valve” such as the control valves 170 to 176 provided in the center bypass oil passage 40. In the illustrated example, the control valve 177 is configured such that the valve position is switched between a first valve position (left valve position), a second valve position (right valve position), and a third valve position (center valve position) in response to a control command from the controller 30.

Specifically, the control valve 177 is in the first valve position, which serves as an initial valve position, when an opening/closing operation of the arm 5 is not performed or when an opening/closing operation of the arm 5 is performed independently. Further, the control valve 177 is in the second valve position when a process for intentionally increasing the load on the drive source 11 is performed, and is in the third valve position when a combined operation of an opening/closing operation of the arm 5 and a swing operation or the like is performed.

More specifically, the control valve 177 is configured such that the control valve 177 is in the third valve position and functions as a swing priority valve when a combined operation including an opening/closing operation of the arm 5 and a swing operation is performed. Therefore, the cross-sectional area of a third fixed throttle AP3 provided in an oil passage connecting the upstream side and the downstream side of the control valve 177 in the third valve position (center valve position) is smaller than the cross-sectional area of a first fixed throttle AP1 provided in an oil passage connecting the upstream side and the downstream side of the control valve 177 in the first valve position (left valve position). With this configuration, for example, when the arm cylinder 8 and the swing hydraulic motor 21 are simultaneously operated and the load pressure of the arm cylinder 8 is lower than that of the swing hydraulic motor 21, the third fixed throttle AP3 can prevent most of hydraulic oil discharged by the left main pump 14L from flowing into the arm cylinder 8 having a lower load pressure. This is because the third fixed throttle AP3 can increase the pressure of hydraulic oil on its upstream side when hydraulic oil flows into the arm cylinder 8 through the control valve 177. Therefore, the hydraulic drive system including the third fixed throttle AP3 can reliably operate not only the arm cylinder 8 having a lower load pressure but also the swing hydraulic motor 21 having a higher load pressure even when, for example, the arm cylinder 8 having a lower load pressure and the swing hydraulic motor 21 having a higher load pressure are simultaneously operated. In the following, a function implemented by such a swing priority valve is also referred to as a “swing priority function”. Further, the first fixed throttle AP1 and the third fixed throttle AP3 may be implemented by one variable throttle. For example, the oil passage in the first valve position (left valve position) may be provided with one variable throttle that functions as both the first fixed throttle AP1 and the third fixed throttle AP3. In this case, the third valve position may be omitted.

In the illustrated example, the control valves 170 to 176 are pilot-type spool valves, and each pilot port is hydraulically connected to the operation device 26 serving as a hydraulic operation device. However, each pilot port of the control valves 170 to 176 is not necessarily hydraulically connected to the operation device 26 in a case where the operation device 26 is an electric type. Specifically, in a case where an operation lever, serving as the operation device 26, is an electric operation lever, the lever operating amount and the lever operating direction are input into the controller 30 as electric signals. In this case, an electromagnetic valve is typically disposed between the pilot pump 15 and a pilot port of each control valve. The electromagnetic valve is configured to operate in response to an electric signal from the controller 30. With this configuration, upon a manual operation using the operation lever being performed, the controller 30 controls the electromagnetic valve based on an electric signal corresponding to the lever operating amount to increase or decrease the pilot pressure such that each control valve is moved (stroked). Each control valve may be configured as an electromagnetic spool valve. In this case, the electromagnetic spool valve operates in response to an electrical signal from the controller 30 corresponding to the operating amount of the electric operation lever.

A return oil passage 41 is a hydraulic oil line disposed in the control valve unit 17, and includes a center return oil passage 41C, a left return oil passage 41L, and a right return oil passage 41R. In the illustrated example, the center return oil passage 41C is a return oil passage connecting a relief valve 55 and the hydraulic oil tank T1. The left return oil passage 41L is a return oil passage connecting each of the control valves 171L, 172, 173, 175L, and 176L and the hydraulic oil tank T1. The right return oil passage 41R is a return oil passage connecting each of the control valves 170, 171R, 174, 175R, and 176R and the hydraulic oil tank T1.

The relief valve 55 is a device for maintaining the pressure of hydraulic oil in the hydraulic drive system at a predetermined relief pressure or lower. In the illustrated example, an upstream port of the relief valve 55 is connected to each of the left center bypass oil passage 40L and the right center bypass oil passage 40R via a check valve, and a downstream port of the relief valve 55 is connected to the hydraulic oil tank T1 via the center return oil passage 41C. The relief valve 55 is configured to be maintained in a closed state when the pressure of hydraulic oil on the upstream side (the pressure of the hydraulic oil in the hydraulic drive system) is lower than the predetermined relief pressure, and is configured to be opened when the pressure of hydraulic oil on the upstream side is higher than or equal to the predetermined relief pressure. In the illustrated example, the relief valve 55 is a fixed relief valve in which the relief pressure is fixed, but the relief valve 55 may be a variable electromagnetic relief valve in which the relief pressure can be adjusted.

A parallel oil passage 42 is a hydraulic oil line parallel to the center bypass oil passage 40. In the illustrated example, the parallel oil passage 42 includes the left parallel oil passage 42L parallel to the left center bypass oil passage 40L and a right parallel oil passage 42R parallel to the right center bypass oil passage 40R. When the flow of hydraulic oil through the left center bypass oil passage 40L is restricted or shut off by the control valve 171L, 172, 173 or 175L, the left parallel oil passage 42L can supply hydraulic oil to a control valve further downstream. When the flow of hydraulic oil through the right center bypass oil passage 40R is restricted or shut off by the control valve 171R, 174 or 175R, the right parallel oil passage 42R can supply hydraulic oil to a control valve further downstream.

A throttle 60 is a fixed throttle provided in the right parallel oil path 42R that is on the upstream side of the control valve 176R and on the downstream side of a branching point at which an oil path that joins the right parallel oil path 42R and the control valve 175R branches from the right parallel oil path 42R. In the illustrated example, for example, the throttle 60 has a function for preventing most of the hydraulic oil discharged by the right main pump 14R from flowing into the arm cylinder 8 having a low load pressure, when the arm cylinder 8 having a low load pressure and a hydraulic actuator (at least one of the boom cylinder 7, the bucket cylinder 9, or the right travel hydraulic motor 20R) having a high load pressure are simultaneously operated. This is because the throttle 60 can increase the pressure of hydraulic oil on its downstream side when hydraulic oil flows into the arm cylinder 8 through the control valve 176R. Therefore, even when the arm cylinder 8 having a low load pressure and the boom cylinder 7 having a high load pressure are simultaneously operated, for example, the hydraulic drive system including the throttle 60 can reliably operate not only the arm cylinder 8 having a low load pressure but also the boom cylinder 7 having a high load pressure. The same applies to a case where the arm cylinder 8 having a low load pressure and the bucket cylinder 9 or the right travel hydraulic motor 20R having a high load pressure are simultaneously operated.

Here, negative control adopted in the hydraulic drive system of FIG. 2 will be described. A throttle 18 is disposed in the center bypass oil passage 40 between the most downstream control valve 176 and the hydraulic oil tank T1. The flow of hydraulic oil discharged by the main pump 14 is restricted by the throttle 18. The throttle 18 generates a control pressure (negative control pressure) for controlling the pump regulator 13. Specifically, the throttle 18 is a fixed throttle whose opening area is fixed, and includes a left throttle 18L and a right throttle 18R. However, the throttle 18 may be a variable throttle whose opening area is variable. The throttle 18 tends to increase stability against a sudden change in a control pressure as the opening area increases. Further, the throttle 18 tends to increase the responsiveness of a control pressure as the opening area decreases. The flow of hydraulic oil discharged by the left main pump 14L is restricted by the left throttle 18L. Then, the left throttle 18L generates a control pressure for controlling the left pump regulator 13L. Likewise, the flow of hydraulic oil discharged by the right main pump 14R is restricted by the right throttle 18R. Then, the right throttle 18R generates a control pressure for controlling the right pump regulator 13R.

A control pressure sensor 19 is a sensor that detects a control pressure (negative control pressure) generated upstream of the throttle 18, and includes a left control pressure sensor 19L and a right control pressure sensor 19R. In the illustrated example, the control pressure sensor 19 is configured to output a detected value to the controller 30. The controller 30 outputs a command corresponding to the control pressure to the pump regulator 13. The pump regulator 13 controls the discharge amount of the main pump 14 by adjusting the swash plate tilt angle of the main pump 14 in response to the command. Specifically, the pump regulator 13 decreases the discharge amount of the main pump 14 as the control pressure increases, and increases the discharge amount of the main pump 14 as the control pressure decreases.

Because of the negative control, the hydraulic drive system of FIG. 2 can control unnecessary energy consumption in the main pump 14 when none of the hydraulic actuators are operated. The unnecessary energy consumption includes pumping loss that hydraulic oil discharged by the main pump 14 causes in the center bypass oil passage 40. The hydraulic drive system of FIG. 2 can ensure that when a hydraulic actuator is operated, necessary and sufficient hydraulic oil is supplied from the main pump 14 to the operated hydraulic actuator.

The center bypass oil passage 40 and the return oil passage 41 are connected to a junction with an oil passage 43 downstream of the throttle 18. In the illustrated example, the oil passage 43 bifurcates downstream of the junction to be connected to an oil passage 45 and an oil passage 46 outside the control valve unit 17. That is, hydraulic oil flowing through the center bypass oil passage 40 and hydraulic oil flowing through the return oil passage 41 merge with each other in the oil passage 43 and thereafter arrive at the hydraulic oil tank T1 through the oil passage 45 and the oil passage 46. Further, the oil passage 43 is connected to the swing hydraulic motor 21 via the oil passage 44 that is a hydraulic oil line for compensating for a shortage of hydraulic oil on the intake side of the swing hydraulic motor 21.

The oil passage 45 is a hydraulic oil line that connects the oil passage 43 and the hydraulic oil tank T1. A check valve 50, an oil cooler 51, and a filter 53 are disposed in the oil passage 45.

The check valve 50 is a valve that opens when the pressure difference between the primary side and the secondary side exceeds a predetermined valve opening pressure difference. In the illustrated example, the check valve 50 is a spring check valve, and opens to cause hydraulic oil in the control valve unit 17 to flow out toward the oil cooler 51 when the upstream pressure is higher than the downstream pressure and the pressure difference exceeds the valve opening pressure difference. This configuration enables the check valve 50 to maintain the pressure of hydraulic oil in the oil passage 43 and the oil passage 44 at a level higher than a valve opening pressure and ensure that the shortage of hydraulic oil on the intake side of the swing hydraulic motor 21 is compensated for. In this case, the valve opening pressure is the lower limit value of a back pressure against the throttle 18. The back pressure against the throttle 18 increases as the flow rate of hydraulic oil passing through the check valve 50 increases. The check valve 50 may be integrated into the control valve unit 17 or may be omitted. In a case where the check valve 50 is omitted, a pressure loss in each of the oil passage 45, the check valve 50, the oil cooler 51, and the filter 53 becomes a back pressure against the throttle 18. The back pressure against the throttle 18 increases as the flow rate of hydraulic oil passing through the oil passage 45 increases.

The oil cooler 51 is a device for cooling hydraulic oil that circulates in the hydraulic drive system. In the illustrated example, the oil cooler 51 is included in a heat exchanger unit cooled by a cooling fan driven by the drive source 11. The heat exchanger unit includes a radiator, an intercooler, the oil cooler 51, and the like. Further, in the illustrated example, the oil passage 45 includes an oil passage section 45a that connects the check valve 50 and the oil cooler 51 and an oil passage section 45b that connects the oil cooler 51 and the hydraulic oil tank T1. The filter 53 is disposed in the oil passage section 45b.

The oil passage 46 is a bypass oil passage that bypasses the oil cooler 51. In the illustrated example, the oil passage 46 has one end connected to the oil passage 43 and the other end connected to the hydraulic oil tank T1. The one end of the oil passage 46 may be connected to the oil passage 45 between the check valve 50 and the oil cooler 51. Further, a check valve 52 is disposed in the oil passage 46.

Similar to the check valve 50, the check valve 52 is a valve that opens when the pressure difference between the primary side and the secondary side exceeds a predetermined valve opening pressure difference. In the illustrated example, the check valve 52 is a spring check valve, and opens to cause hydraulic oil in the control valve unit 17 to flow out toward the hydraulic oil tank T1 when the upstream pressure is higher than the downstream pressure and the pressure difference exceeds the valve opening pressure difference. The valve opening pressure difference for the check valve 52 is greater than the valve opening pressure difference for the check valve 50. Therefore, hydraulic oil in the control valve unit 17 first flows through the check valve 50, and thereafter, when the pressure exceeds the valve opening pressure because of resistance during passage through the oil cooler 51, flows through the check valve 52. The check valve 52 may be integrated into the control valve unit 17.

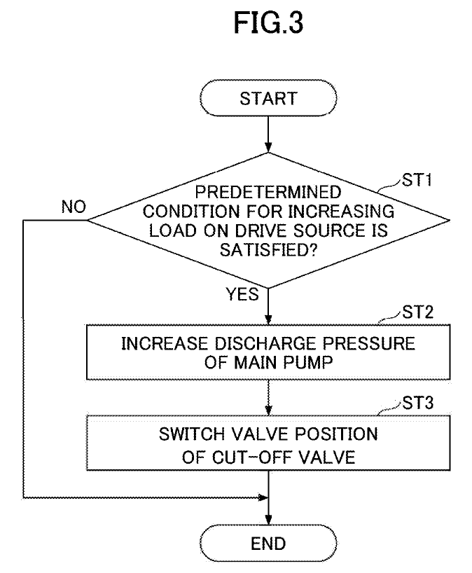

Next, a process for intentionally increasing the load on the drive source 11 (hereinafter referred to as a “forced high-load process”) will be described with reference to FIG. 3. FIG. 3 is a flowchart illustrating an example of the flow of the forced high-load process. In the illustrated example, the controller 30 is configured to repeatedly execute the forced high-load process in a predetermined control cycle while the drive source 11 is in operation. In the following, a function implemented by the forced high-load process is also referred to as a “forced high-load function”.

First, the controller 30 determines whether a predetermined condition for increasing the load on the drive source 11 is satisfied (step ST1). In the illustrated example, the controller 30 determines that the predetermined condition is satisfied when a predetermined button is pressed. The predetermined button is a graphic image serving as a software button displayed on a touch panel monitor serving as a display device provided in the cabin 10. The predetermined button may be a hardware button attached to the display device provided in the cabin 10 or a hardware button provided at another position in the cabin 10.

Alternatively, the controller 30 may determine that the predetermined condition is satisfied when a predetermined speech command is input through a speech input device such as a microphone provided in the cabin 10.

Alternatively, the controller 30 may determine that the predetermined condition is satisfied when the work machine 100 is put into in an inoperable state by a gate lock lever or the like and the boom operation lever is operated in the lowering direction. The inoperable state refers to a state in which a hydraulic actuator cannot be operated even when the operation device 26 is operated, for example, a state in which an oil passage between the pilot pump 15 and a pilot port of each control valve is shut off.

Alternatively, the controller 30 may determine that the predetermined condition is satisfied when the operation device 26 is not operated and also a predetermined time has come, the outside air temperature is lower than or equal to a predetermined lower limit temperature, the outside air temperature is higher than or equal to a predetermined upper limit temperature, or the operating time period of the drive source 11 exceeds a predetermined time period.

If the controller 30 determines that the predetermined condition is not satisfied (NO in step ST1), the controller 30 ends the present forced high-load process. This is because it is determined that there is no need to intentionally increase the load on the drive source 11.

Conversely, if the controller 30 determines that the predetermined condition is satisfied (YES in step ST1), the controller 30 increases the discharge pressure of the main pump 14 (step ST2). In the illustrated example, the controller 30 increases the discharge pressure of the left main pump 14L by shutting off the left center bypass oil passage 40L. Specifically, the controller 30 outputs a control command to the electromagnetic valve 31 to increase the pilot pressure acting on the left pilot port of the control valve 175L. When the pilot pressure acting on the left pilot port increases, the valve position of the control valve 175L is switched to the first valve position (left valve position), and the flow of hydraulic oil from the left main pump 14L to the hydraulic oil tank T1 through the left center bypass oil passage 40L can be shut off. At this time, the hydraulic oil does not flow out of the bottom-side oil chamber of the boom cylinder 7. That is, a lowering operation of the boom 4 is not performed. This is because a holding valve (not illustrated) prevents the hydraulic oil from flowing out of the bottom-side oil chamber of the boom cylinder 7.

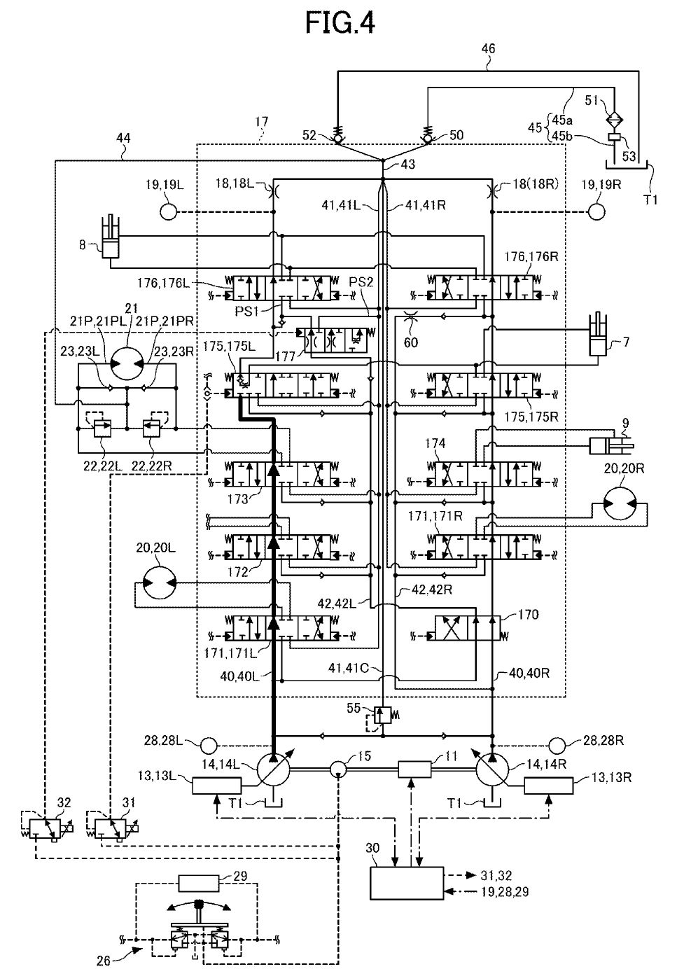

FIG. 4 is a diagram illustrating a state of the hydraulic drive system when the controller 30 switches the valve position of the control valve 175L from the third valve position (center valve position) to the first valve position (left valve position). For the sake of clarity, in FIG. 4, a bold solid line indicates an increase in the pressure of hydraulic oil in the left center bypass oil passage 40L, which is shut off by the control valve 175L.

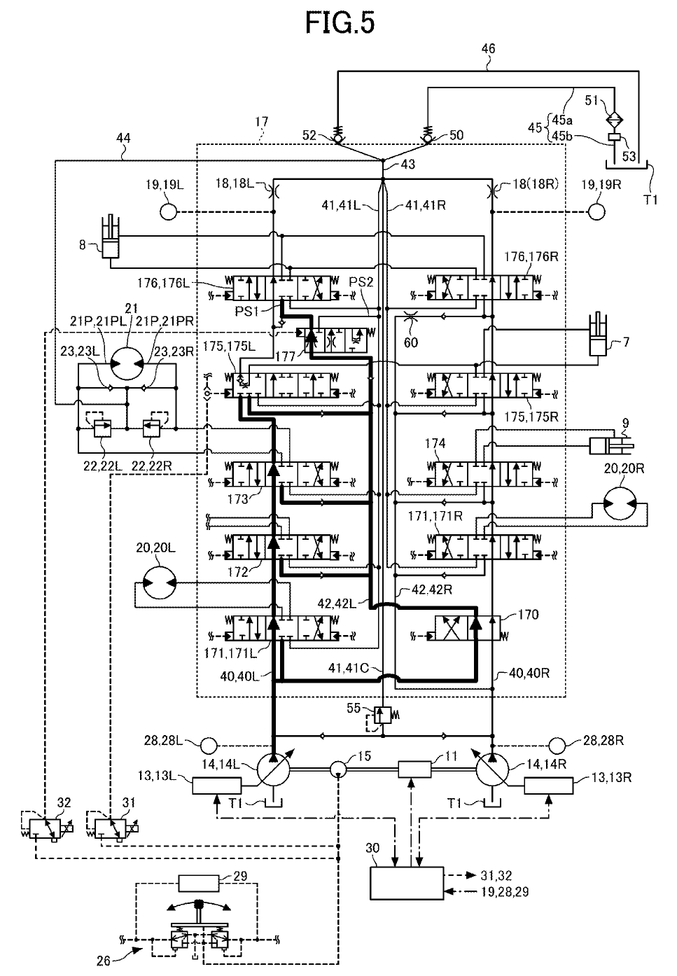

Further, when the left center bypass oil passage 40L is shut off by the control valve 175L, the pressure of hydraulic oil in the left parallel oil passage 42L upstream of the control valve 176L also increases as illustrated in FIG. 5. FIG. 5 is a diagram illustrating a state of the hydraulic drive system when the pressure of hydraulic oil in the left parallel oil passage 42L increases. For the sake of clarity, in FIG. 5, bold solid lines indicate an increase in the pressure of hydraulic oil in the left parallel oil passage 42L in addition to the increase in the pressure of hydraulic oil in the left center bypass oil passage 40L.

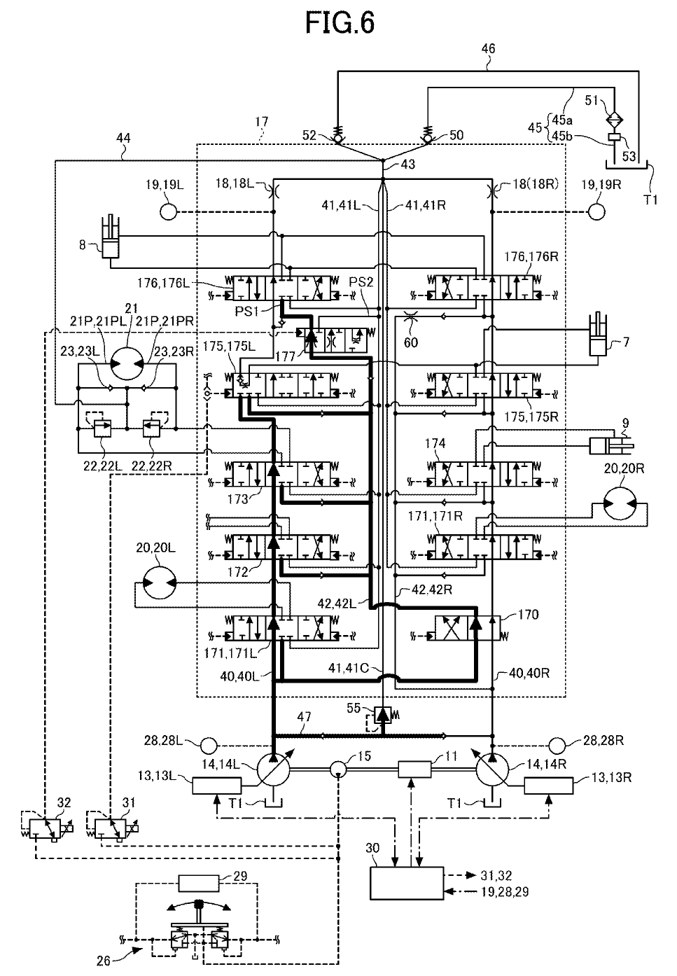

Further, when the pressure of hydraulic oil in the left center bypass oil passage 40L and the pressure of hydraulic oil in the left parallel oil passage 42L increase, that is, when the discharge pressure of the left main pump 14L increases, the pressure of hydraulic oil in an oil passage 47 connecting the left main pump 14L and the relief valve 55 also increases as illustrated in FIG. 6. FIG. 6 is a diagram illustrating a state of the hydraulic drive system when the pressure of hydraulic oil in the oil passage 47 increases. For the sake of clarity, in FIG. 6, bold solid lines indicate an increase in the pressure of hydraulic oil in the oil passage 47 in addition to the increase in the pressure of hydraulic oil in the left center bypass oil passage 40L and the increase in the pressure of hydraulic oil in the left parallel oil passage 42L.

When each of the pressure of hydraulic oil in the left center bypass oil passage 40L, the pressure of hydraulic oil in the left parallel oil passage 42L, and the pressure of hydraulic oil in the oil passage 47 exceeds a predetermined relief pressure, the hydraulic oil is discharged to the center return oil passage 41C through the relief valve 55. Then, the hydraulic oil discharged from the relief valve 55 flows into the hydraulic oil tank T1 through the center return oil passage 41C, the oil passage 43, and the oil passage 45.

In this manner, the controller 30 can maintain the hydraulic load (pump torque) of the main pump 14 in a high state for a desired period of time, and can consequently maintain the load on the drive source 11 in a high state.

Referring back to FIG. 3, the description of the flow of the forced high-load process is continued. In the illustrated example, after increasing the discharge pressure of the main pump 14, the controller 30 switches the valve position of the cut-off valve (step ST3). In the illustrated example, the controller 30 outputs a control command to the electromagnetic valve 32 to increase the pilot pressure acting on the pilot port of the control valve 177. When the pilot pressure acting on the pilot port is increased, the valve position of the control valve 177 illustrated in FIG. 2 is switched to the second valve position (right valve position), and the left parallel oil passage 42L can be shut off. At this time, an oil passage section PS1, of the left parallel oil passage 42L, connecting the control valve 177 and the control valve 176L is connected to an oil passage PS2 connecting the control valve 177 and the left return oil passage 41L. As a result, a portion of the hydraulic oil in the oil passage section PS1 is discharged to the left return oil passage 41L through the oil passage PS2, and the pressure of the hydraulic oil in the oil passage section PS1 is reduced. The oil passage PS2 is also referred to as a bleed oil passage.

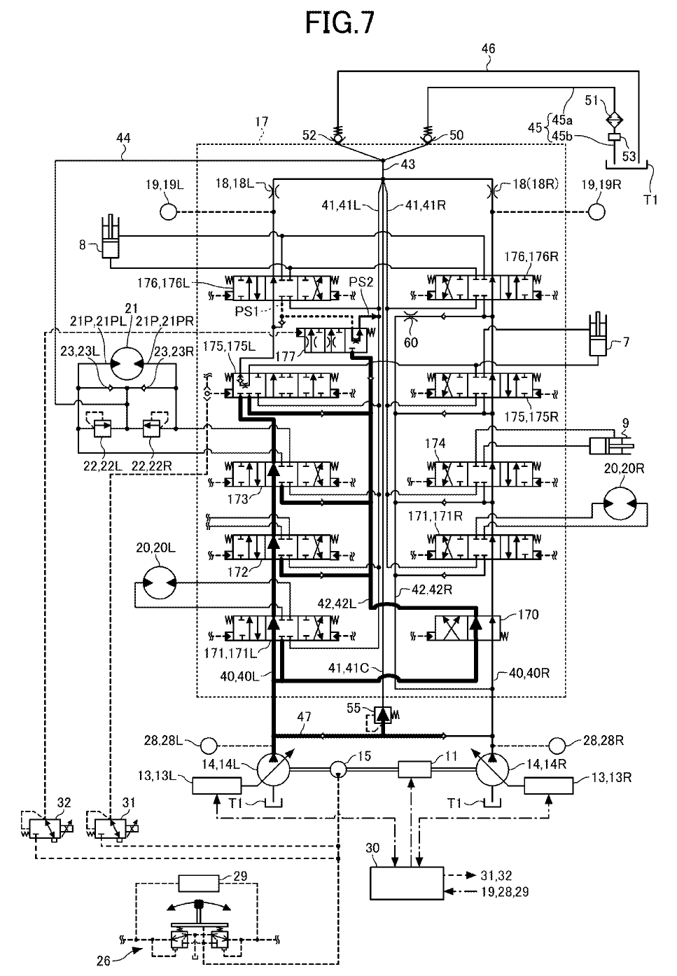

FIG. 7 is a diagram illustrating a state of the hydraulic drive system when the controller 30 switches the valve position of the control valve 177 to the second valve position (right valve position). For the sake of clarity, in FIG. 7, a thick dotted line indicates the oil passage section PS1, and thick arrows indicate that a portion of the hydraulic oil in the oil passage section PS1 is discharged to the left return oil passage 41L via the oil passage PS2.

When a portion of the hydraulic oil in the oil passage section PS1 is discharged to the left return oil passage 41L and the pressure of the hydraulic oil in the oil passage section PS1 decreases, the difference between the pressure of the hydraulic oil on the upstream side of the control valve 176L and the pressure of the hydraulic oil on the downstream side of the control valve 176L (the pressure difference across the control valve 176L) decreases. The pressure difference across the control valve 176L is the difference between the pressure of the hydraulic oil on the upstream side of the control valve 176L and the pressure of the hydraulic oil on the downstream side of the control valve 176L when the pressure of the hydraulic oil on the upstream side is larger than the pressure of the hydraulic oil on the downstream side. The pressure difference across the control valve 176L provides an effect of suppressing leakage of the hydraulic oil from the upstream side to the downstream side of the control valve 176L through a substantially annular gap between a substantially cylindrical spool portion of the control valve 176L and a valve block portion having a substantially cylindrical space for accommodating the spool portion. Further, suppressing leakage of the hydraulic oil provides an effect of suppressing the inflow of the hydraulic oil into each of a rod-side oil chamber and a bottom-side oil chamber of the arm cylinder 8, thereby preventing the pressure of the rod-side oil chamber and the pressure of the bottom-side oil chamber from becoming substantially equal to each other. Further, preventing the pressure of the rod-side oil chamber and the pressure of the bottom-side oil chamber of the arm cylinder 8 from becoming substantially equal to each other provides an effect of minimizing extension of the arm cylinder 8 that is not intended by the operator, that is, an effect of suppressing the occurrence of an arm closing operation that is not intended by the operator. This is because when the pressure of the rod-side oil chamber and the pressure of the bottom-side oil chamber of the arm cylinder 8 become substantially equal to each other, a piston in the arm cylinder 8, which is a single-rod hydraulic cylinder, moves in a direction in which the bottom-side oil chamber expands due to a difference in the pressure-receiving areas. In the illustrated example, the pressure-receiving area of the piston facing the bottom-side oil chamber is approximately twice as large as the pressure-receiving area of the piston facing the rod-side oil chamber. Therefore, if the pressure of the rod-side oil chamber and the pressure of the bottom-side oil chamber of the arm cylinder 8 are substantially equal to each other, the thrust force for moving the piston toward the cylinder extension side (the arm closing side) is approximately twice as large as the thrust force for moving the piston toward the cylinder contraction side (the arm opening side). A holding valve (not illustrated) for preventing the arm 5 from moving due to its own weight or the like when an arm operation is not performed (a valve for preventing hydraulic oil from flowing out of the arm cylinder 8) may be provided between the arm cylinder 8 and the control valve 176.

As described above, the hydraulic drive system described above provides an effect of minimizing unintended extension of the arm cylinder 8 caused by the pressure of the hydraulic oil on the upstream side of the control valve 176L becoming larger than the pressure of the hydraulic oil on the downstream side of the control valve 176L during the forced high-load process performed when the operation device 26 is not operated, for example. This is because the controller 30 can cause a portion of the hydraulic oil in the oil passage section PS1 to return to the hydraulic oil tank T1, thereby preventing the pressure of the hydraulic oil in the oil passage section PS1 from being kept high and preventing the pressure difference across the control valve 176L from being kept large while the forced high-load process is performed.

Further, in the above-described configuration, even when the hydraulic oil leaks from the upstream side to the downstream side of the control valve 177 through the substantially annular gap between the substantially cylindrical spool portion of the control valve 177 and the valve block portion, the leaked hydraulic oil is discharged to the left return oil passage 41L through the oil passage PS2. Therefore, the hydraulic oil leaked through the substantially annular gap around the control valve 177 does not increase the pressure difference across the control valve 176L.

In the above-described example, the controller 30 prevents a large pressure difference across the control valve 176L from being maintained by switching the valve position of the control valve 177 to the second valve position (right valve position) after switching the valve position of the control valve 175L to the first valve position (left valve position). However, the controller 30 may prevent an increase in the pressure difference across the control valve 176L by switching the valve position of the control valve 177 to the second valve position (right valve position) at the same time when the valve position of the control valve 175L is switched to the first valve position (left valve position). Alternatively, the controller 30 may prevent an increase in the pressure difference across the control valve 176L by switching the valve position of the control valve 177 to the second valve position (right valve position) before switching the valve position of the control valve 175L to the first valve position (left valve position).

Further, the control valve 177 is configured such that an increase in the pressure difference across the control valve 177 is suppressed by bringing a port on the downstream side of the control valve 177 into communication with the return oil passage 41. However, the control valve 177 may be configured such that the port on the downstream side of the control valve 177 is not brough into communication with the return oil passage 41. This is because, for example, if the valve position of the control valve 177 is switched to the second valve position (right valve position) at the same time when the valve position of the control valve 175L is switched to the first valve position (left valve position), an increase in the pressure difference across the control valve 177 can be prevented. The same applies to a case where the valve position of the control valve 177 is switched to the second valve position (right valve position) before the valve position of the control valve 175L is switched to the first valve position (left valve position). Further, even if the valve position of the control valve 177 is switched to the second valve position (right valve position) after the valve position of the control valve 175L is switched to the first valve position (left valve position), the control valve 177 may be configured such that the port on the downstream side of the control valve 177 is not brought into communication with the return oil passage 41. This is because even when the left parallel oil passage 42L is shut off only by the control valve 177, the hydraulic drive system can prevent a large pressure difference across the control valve 176L from being maintained for a long period of time.

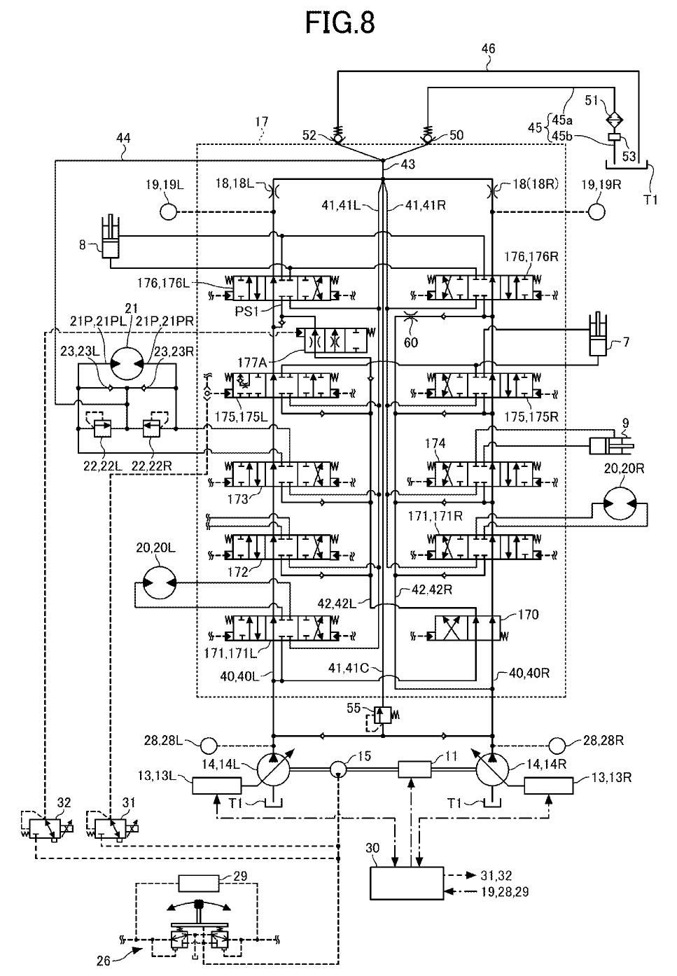

Referring now to FIG. 8, an example configuration of another hydraulic drive system installed in the work machine 100 of FIG. 1 will be described. FIG. 8 is a diagram illustrating the configuration example of the other hydraulic drive system installed in the work machine 100 of FIG. 1, and corresponds to FIG. 2. The hydraulic drive system illustrated in FIG. 8 differs from the hydraulic drive system illustrated in FIG. 2 in that the hydraulic drive system illustrated in FIG. 8 includes a control valve 177A instead of the control valve 177, and the control valve 177A is not connected to the return oil passage 41. However, the hydraulic drive system illustrated in FIG. 8 is the same as the hydraulic drive system illustrated in FIG. 2 in other respects. Therefore, the description of the common parts will be omitted, and differences will be described in detail below.

The control valve 177A is configured to restrict the flow rate of hydraulic oil flowing through the left parallel oil passage 42L toward the control valve 176L. In the illustrated example, the control valve 177A is configured such that the valve position is switched among a first valve position (left valve position), a second valve position (right valve position), and a third valve position (center valve position) in response to a control command from the controller 30.

More specifically, the control valve 177A is in the first valve position, which serves as an initial valve position, when an opening/closing operation of the arm 5 is not performed or when an opening/closing operation of the arm 5 is performed independently. The control valve 177A is in the second valve position when a process for intentionally increasing the load on the drive source 11 is performed, and the control valve 177A is in the third valve position when a combined operation of an opening/closing operation of the arm 5 and a swing operation or the like is performed. In the illustrated example, the control valve 177A is configured such that the control valve 177A is in the third valve position and functions as a swing priority valve when a combined operation including an opening/closing operation of the arm 5 and a swing operation is performed.

When a predetermined condition for intentionally increasing the load on the drive source 11 is satisfied and the valve position of the control valve 177A is switched to the second valve position, the control valve 177A shuts off the left parallel oil passage 42L. At this time, because the oil passage section PS1, of the left parallel oil passage 42L, connecting the control valve 177 and the control valve 176L is not connected to the return oil passage 41, the pressure of the hydraulic oil in the oil passage section PS1 is maintained at the same pressure as when the valve position of the control valve 177A is switched to the second valve position.

Therefore, the controller 30 can suppress an increase in the pressure of the hydraulic oil in the oil passage section PS1 to a relief pressure, by switching the valve position of the control valve 177A to the second valve position before switching the valve position of the control valve 175L to the first valve position (left valve position). That is, the controller 30 can prevent a large pressure difference across the control valve 176L from being maintained while the forced high-load process is performed.

As described above, similar to the hydraulic drive system illustrated in FIG. 2, the hydraulic drive system illustrated in FIG. 8 provides an effect of minimizing unintended extension of the arm cylinder 8 caused by an increase in the pressure difference across the control valve 176L during the forced high-load process.

In the hydraulic drive system illustrated in FIG. 2, the control valve 177 is configured such that the swing priority function is implemented by switching from the first valve position to the third valve position, and the forced high-load function is implemented by switching from the first valve position to the second valve position. However, the swing priority function and the forced high-load function may be implemented by separate control valves independent of each other. That is, the third valve position of the control valve 177 may be omitted. In this case, the control valve 177 may be disposed upstream of a branch point BP1 (see FIG. 2), upstream of a branch point BP2 (see FIG. 2), or upstream of a branch point BP3 (see FIG. 2) in the left parallel oil passage 42L. Alternatively, the control valve 177 may be disposed upstream of the control valve 170 in the left parallel oil passage 42L. Further, the swing priority function may be implemented by another control valve that does not have a second valve position. The same applies to the control valve 177A of the hydraulic drive system illustrated in FIG. 8.

In other words, the control valve 177 may be implemented by adding a valve position to an existing control valve such as a swing priority valve (a control valve already incorporated into the hydraulic drive system). Further, the existing control valve may be a control valve other than a swing priority valve, such as a regeneration valve or a regenerative valve.

Further, in the above-described embodiment, the hydraulic drive system increases the load on the drive source 11 by shutting off an oil passage through which hydraulic oil discharged by the left main pump 14L flows so as to increase the discharge pressure of the left main pump 14L and increase the hydraulic load (pump torque). However, the hydraulic drive system may increase the load on the drive source 11 by shutting off an oil passage through which hydraulic oil discharged by the right main pump 14R flows so as to increase the discharge pressure of the right main pump 14R and increase the hydraulic load (pump torque). In this case, the control valve 177 is disposed in the right parallel oil passage 42R.

As described above, as illustrated in FIGS. 1 and 2, a work machine 100 according to an embodiment of the present disclosure includes a lower traveling body 1, an upper swing body 3 swingably mounted on the lower traveling body 1, a hydraulic actuator (arm cylinder 8), a hydraulic pump (main pump 14) configured to supply hydraulic oil to the hydraulic actuator (arm cylinder 8), a first control valve (control valve 175L) provided in a first oil passage (center bypass oil passage 40) connecting the hydraulic pump (main pump 14) and a hydraulic oil tank T1, a second control valve (control valve 176L) provided in a second oil passage (parallel oil passage 42) connecting the hydraulic pump (main pump 14) and the hydraulic actuator (arm cylinder 8), and a third control valve (control valve 177) provided between the hydraulic pump (main pump 14) and the second control valve (control valve 176L) in the second oil passage (parallel oil passage 42). The third control valve (control valve 177) is configured to shut off the second oil passage (parallel oil passage 42) when a load on a drive source 11 is intentionally increased. For example, the third control valve (control valve 177) is configured to shut off the second oil passage (parallel oil passage 42) when the first oil passage (center bypass oil passage 40) is shut off by the first control valve (control valve 175L) and the second oil passage (parallel oil passage 42) is shut off by the second control valve (control valve 176L).

This configuration can shut off the first control valve (control valve 175L) in the first oil passage (center bypass oil passage 40) and shut off the third control valve (control valve 177), which is located upstream of the second control valve (control valve 176L), in the second oil passage (parallel oil passage 42). Therefore, this configuration can increase the hydraulic load (pump torque) of the hydraulic pump (main pump 14). Further, this configuration can intentionally increase the load on the drive source 11 while suppressing an increase in the pressure difference across the second control valve (control valve 176L) in the second oil passage (parallel oil passage 42). That is, the forced high-load process can be performed. Further, because this configuration can suppress an increase in the pressure difference across the second control valve (control valve 176L), leakage of the hydraulic oil from the upstream side to the downstream side of the second control valve (control valve 176L) in the second oil passage (parallel oil passage 42) can be suppressed. Therefore, this configuration allows the hydraulic oil leaking to the downstream side of the second control valve (control valve 176L) to be less likely to flow into the hydraulic actuator (arm cylinder 8), and can consequently minimize a movement of the hydraulic actuator (arm cylinder 8) that is not intended by the operator.

Further, as illustrated in FIG. 2, the third control valve (control valve 177) may be configured to be switchable between a first state and a second state. In this case, in the first state, a flow of the hydraulic oil from the hydraulic pump (main pump 14) to the second control valve (control valve 176L) may be permitted. In the second state, the flow of the hydraulic oil from the hydraulic pump (main pump 14) to the second control valve (control valve 176L) may be shut off, and a flow of the hydraulic oil from the oil passage section PS1 located between the third control valve (control valve 177) and the second control valve (control valve 176L) in the second oil passage (parallel oil passage 42) to the hydraulic oil tank T1 may be permitted. Further, the third control valve (control valve 177) may be configured to adjust the flow rate of the hydraulic oil flowing from the hydraulic pump (main pump 14) to the second control valve (control valve 176L) when the third control valve (control valve 177) is in the first state. For example, the third control valve (control valve 177) may be configured to be switchable between a first valve position (left valve position) and a second valve position (right valve position). In this case, in the first valve position (left valve position), the flow of the hydraulic oil from the hydraulic pump (main pump 14) to the second control valve (control valve 176L) may be permitted. Further, in the second valve position (right valve position), the flow of the hydraulic oil from the hydraulic pump (main pump 14) to the second control valve (control valve 176L) may be shut off, and the flow of the hydraulic oil from the oil passage section PS1 located between the third control valve (control valve 177) and the second control valve (control valve 176L) in the second oil passage (parallel oil passage 42) to the hydraulic oil tank T1 may be permitted. In the illustrated example, the control valve 177 has three valve positions, and the first valve position and the second valve position are a left valve position and a right valve position, respectively. However, the first valve position and the second valve position may be any of the three valve positions. For example, the control valve 177 may be configured such that the first valve position and the second valve position are the left valve position and a center valve position or the center valve position and the left valve position, respectively.

This configuration can provide an effect of performing the forced high-load process while further suppressing an increase in the pressure difference across the second control valve (control valve 176L) in the second oil passage (parallel oil passage 42). This is because this configuration can connect the oil passage section PS1 upstream of the second control valve (control valve 176L) in the second oil passage (parallel oil passage 42) to the return oil passage 41. Specifically, this is because this configuration can reduce the pressure of the hydraulic oil in the oil passage section PS1. Further, this is because, even when the hydraulic oil leaks from the upstream side to the downstream side of the third control valve (control valve 177) in the second oil passage (parallel oil passage 42), this configuration can discharge the leaked hydraulic oil to the return oil passage 41. That is, this is because this configuration can suppress an increase in the pressure of the hydraulic oil in the oil passage section PS1 caused by the hydraulic oil leaked from the upstream side to the downstream side of the third control valve (control valve 177).

Further, the hydraulic actuator (arm cylinder 8) may be a single-rod hydraulic cylinder as illustrated in FIGS. 1 and 2.

This configuration provides an effect of minimizing a movement of the single-rod hydraulic cylinder that is not intended by the operator. This is because this configuration can suppress the inflow of the hydraulic oil, which has leaked to the downstream side of the second control valve (control valve 176L), into each of a bottom-side oil chamber and a rod-side oil chamber of the single-rod hydraulic cylinder, thereby preventing the pressure of the hydraulic oil in the bottom-side oil chamber and the pressure of the hydraulic oil in the rod-side oil chamber from becoming equal to each other. Specifically, this configuration can minimize extension of the single-rod hydraulic cylinder caused by the difference between the pressure-receiving areas on both sides of a piston in the cylinder when the pressure of the hydraulic oil in the bottom-side oil chamber and the pressure of the hydraulic oil in the rod-side oil chamber become equal to each other. In the illustrated example, the hydraulic drive system is configured to minimize an unintended movement of the arm cylinder 8, which is an example of the single-rod hydraulic cylinder, but may be configured to minimize an unintended movement of the boom cylinder 7 or the bucket cylinder 9. Further, the hydraulic drive system may be configured to minimize an unintended movement of a double-rod hydraulic cylinder, or may be configured to minimize an unintended movement of a hydraulic motor.

Further, as illustrated in FIG. 2, the third control valve (control valve 177) may be a swing priority valve. That is, the third control valve (control valve 177) may be disposed downstream of the branch point BP2.

By adding a valve position to the swing priority valve, which is an existing control valve, this configuration provides an effect of minimizing a movement of the hydraulic actuator (arm cylinder 8) that is not intended by the operator while the forced high-load process is performed. That is, this configuration provides an effect of easily introducing, into the existing hydraulic drive system, a function for minimizing a movement of the hydraulic actuator (arm cylinder 8) that is not intended by the operator while the forced high-load process is performed.

Further, as illustrated in FIG. 2, the hydraulic pump (main pump 14) may include a first main pump (left main pump 14L) and a second main pump (right main pump 14R). In this case, the first oil passage (center bypass oil passage 40) may include a first center bypass oil passage (left center bypass oil passage 40L) and a second center bypass oil passage (right center bypass oil passage 40R). Further, the second oil passage (parallel oil passage 42) may include a first parallel oil passage (left parallel oil passage 42L) parallel to the first center bypass oil passage (left center bypass oil passage 40L) and a second parallel oil passage (right parallel oil passage 42R) parallel to the second center bypass oil passage (right center bypass oil passage 40R). The first control valve (control valve 175L) may be provided in the first center bypass oil passage (left center bypass oil passage 40L), and the second control valve (control valve 176L) and the third control valve (control valve 177) may be provided in the first parallel oil passage (left parallel oil passage 42L).

This configuration can shut off the control valve 175L in the left center bypass oil passage 40L, and can shut off the control valve 177, which is located upstream of the control valve 176L, in the left parallel oil passage 42L. Therefore, this configuration can increase the hydraulic load (pump torque) of the left main pump 14L. Further, this configuration can intentionally increase the load on the drive source 11 while suppressing an increase in the pressure difference across the control valve 176L in the left parallel oil passage 42L. That is, the forced high-load process can be performed. Further, because this configuration can suppress an increase in the pressure difference across the control valve 176L, leakage of the hydraulic oil from the upstream side to the downstream side of the control valve 176L in the left parallel oil passage 42L can be suppressed. Therefore, this configuration can suppress the flow of the hydraulic oil, leaked to the downstream side of the control valve 176L, into the arm cylinder 8, and can consequently minimize a movement of the arm cylinder 8 that is not intended by the operator.

Further, as illustrated in FIGS. 1 and 2, the hydraulic actuator may include the boom cylinder 7 and the arm cylinder 8. In this case, the first control valve (control valve 175L) may be a spool valve configured to control the flow rate of the hydraulic oil flowing into the boom cylinder 7. Further, the second control valve (control valve 176L) may be a spool valve configured to control the flow rate of the hydraulic oil flowing into the arm cylinder 8.

This configuration can cause the control valve 175L configured to control the flow of the hydraulic oil for driving the boom cylinder 7 to shut off the left center bypass oil passage 40L. In addition, this configuration can cause the control valve 177 located upstream of the control valve 176L configured to control the flow of the hydraulic oil for driving the arm cylinder 8 to shut off the left parallel oil passage 42L, and thus an increase in the pressure difference across the control valve 176L in the left parallel oil passage 42L can be suppressed. Therefore, this configuration can suppress leakage of the hydraulic oil from the upstream side to the downstream side of the control valve 176L in the left parallel oil passage 42L. In addition, this configuration can suppress the flow of the hydraulic oil, leaked to the downstream side of the control valve 176L, into the arm cylinder 8, and can consequently minimize a movement of the arm cylinder 8 that is not intended by the operator.

The embodiment of the present disclosure has been described above. However, the present disclosure is not limited to the above-described embodiment. Various modifications, substitutions, and the like are applicable to the above-described embodiment without departing from the scope of the present disclosure. Further, any features described with reference to the above-described embodiment may be combined as appropriate, as long as no technical contradiction occurs.

What is claimed is:

1. A work machine comprising:
a lower traveling body;
an upper swing body configured to be swingably mounted on the lower traveling body;
a hydraulic actuator;
a hydraulic pump configured to supply hydraulic oil to the hydraulic actuator;
a first control valve provided in a first oil passage connecting the hydraulic pump and a hydraulic oil tank;
a second control valve provided in a second oil passage connecting the hydraulic pump and the hydraulic actuator; and
a third control valve provided between the hydraulic pump and the second control valve in the second oil passage, wherein
the third control valve is configured to shut off the second oil passage when a load on a drive source is intentionally increased.

2. The work machine according to claim 1, wherein
the third control valve has a first state and a second state,
in the first state, a flow of the hydraulic oil from the hydraulic pump to the second control valve is permitted, and
in the second state, the flow of the hydraulic oil from the hydraulic pump to the second control valve is shut off, and a flow of the hydraulic oil from an oil passage section located between the third control valve and the second control valve in the second oil passage to the hydraulic oil tank is permitted.

3. The work machine according to claim 1, wherein the hydraulic actuator is a single-rod hydraulic cylinder.

4. The work machine according to claim 1, wherein
the hydraulic pump includes a first main pump and a second main pump,
the first oil passage includes a first center bypass oil passage and a second center bypass oil passage,
the second oil passage includes a first parallel oil passage parallel to the first center bypass oil passage, and a second parallel oil passage parallel to the second center bypass oil passage,
the first control valve is provided in the first center bypass oil passage, and
each of the second control valve and the third control valve is provided in the first parallel oil passage.

5. The work machine according to claim 1, wherein
the hydraulic actuator includes a boom cylinder and an arm cylinder,
the first control valve is a spool valve configured to control a flow rate of the hydraulic oil flowing into the boom cylinder, and
the second control valve is a spool valve configured to control a flow rate of the hydraulic oil flowing into the arm cylinder.

6. The work machine according to claim 1, wherein the third control valve is a swing priority valve.
